(19) United States
(12) Patent Application Publication
(10) Pub. No.: US 2019/0200033 A1
(43) Pub. Date: Jun. 27, 2019

(54) IMAGE ENCODING/DECODING METHODS AND APPARATUSES AND IMAGE PROCESSING EQUIPMENT

(71) Applicant: FUJITSU LIMITED, Kawasaki-shi (JP)

(72) Inventors: Xuan FU, Beijing (CN); Guillaume BARROUX, Kawasaki-shi (JP); Kimihiko KAZUI, Kawasaki-shi (JP)

(73) Assignee: FUJITSU LIMITED, Kawasaki-shi (JP)

(21) Appl. No.: 16/287,705

(22) Filed: Feb. 27, 2019

Related U.S. Application Data
(63) Continuation of application No. PCT/CN2016/102004, filed on Oct. 13, 2016.

(51) Int. Cl. H04N 19/52; H04N 19/119; H04N 19/139; H04N 19/17

(52) U.S. Cl. CPC H04N 19/52; H04N 19/17; H04N 19/139; H04N 19/119

(57) ABSTRACT

Embodiments of this disclosure provide an image encoding/decoding methods and apparatuses and an image processing equipment. The image encoding method includes: determining a search sub-region of a current encoding unit from a plurality of sub-regions of a search region according to one or more motion vectors of one or more encoded units; obtaining one or more motion vectors of the current encoding unit based on the search sub-region; calculating residual information on the current encoding unit according to the motion vectors; and encoding the residual information on the current encoding unit into a bit stream. Hence, the search region may be reduced, and the number of search points may be lowered, thereby shortening PMMVD encoding/decoding time.

### CROSS-REFERENCE TO RELATED APPLICATIONS

This application is a continuation application of PCT International Application No. PCT/CN2016/102004, filed on Oct. 13, 2016, the disclosure of which is incorporated herein by reference.

### TECHNICAL FIELD

This disclosure relates to the field of graphs and images, and in particular to an image encoding/decoding methods and apparatuses and an image processing equipment.

### BACKGROUND

In video coding/decoding (also referred to as image coding/decoding) standards (such as MPEG 2, H.264/AVC, H.265/HEVC), intra coding (also referred to as intra prediction coding) predicts a current block to be encoded by using reconstructed neighboring pixels.

In the video encoding/decoding standards, a motion vector (MV) is used to represent a displacement of a current frame relative to a reference frame; according to this displacement, a decoder may obtain a reference block from a reference image, in addition to residual data obtained by decoding a bit stream (also referred to as a code stream), a decoding value of the current block may be obtained. In the conventional encoding/decoding standards, all MVs are compressed and then encoded into the bit stream, so that the decoder knows where reference data may be taken.

FIG. 1 is a schematic diagram of a motion vector in video encoding/decoding. As shown in FIG. 1, MV denotes, for example, a displacement (e.g. including a direction and a size) of a current coding unit (CU) relative to a reference CU. As shown in FIG. 1, the MV may include motion vector difference (MVD) and motion vector prediction (MVP).

A new tool, i.e. pattern matched motion vector derivation (PMMVD), is introduced into next generation video encoding/decoding standards. In order to save the number of bits (also referred to as a code rate) in a bit stream, PMMVD will not encode an MV in the bit stream; and a decoder selects a candidate with a lowest cost in MV candidates in a same search manner as an encoder and take it as a last MV of the current decoding unit (hereinafter referred to as a CU), and take reference data according to the MV.

FIG. 2 is a schematic diagram of acquiring an MV by a decoder in a PMMVD manner. As shown in FIG. 2, the decoder first performs a first stage of search in a search region, which may be predetermined. In the first stage, a coarse search is performed at an interval of 4 pixels, for example, and a candidate having a best result in the first stage of search may be obtained. Then, a second stage of search is performed around a region to which the candidate having a best result in the first stage corresponds, such as performing fine search at an interval of 2 pixels, and a candidate having a best result in the second stage may be obtained, which is taken as an MV of the current CU.

Since the data of the current CU are unable to be obtained as they are not decoded at the decoder, left 4 columns and upper 4 rows of the current CU may be used to reconstruct data in motion estimation search, both the same for the encoder and the decoder, which may ensure that the search result of the decoder is in consistence with that of the encoder.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that the MV may be obtained through simple calculations in conventional encoding/decoding, but the MV may only be obtained in the PMMVD in the same search process in the decoder as in the encoder. Such a process results in that a decoding time in the decoder reaches 300% of an original time, which poses a great challenge to realization of real-time decoding.

Embodiments of this disclosure provide an image encoding/decoding methods and apparatuses and an image processing equipment, in which it is expected that encoding/decoding times in PMMVD may be shortened.

According to a first aspect of the embodiments of this disclosure, there is provided an image encoding method, in which encoding is performed in a pattern matched motion vector derivation manner, the image encoding method including:
determining a search sub-region of a current encoding unit from a plurality of sub-regions of a search region according to one or more motion vectors of one or more encoded units;
obtaining one or more motion vectors of the current encoding unit based on the search sub-region;
calculating residual information on the current encoding unit according to the motion vectors; and
encoding the residual information on the current encoding unit into a bit stream.

According to a second aspect of the embodiments of this disclosure, there is provided an image encoding apparatus, performing encoding in a pattern matched motion vector derivation manner, the image encoding apparatus including:
a search sub-region determining portion configured to determine a search sub-region of a current encoding unit from a plurality of sub-regions of a search region according to one or more motion vectors of one or more encoded units;
a motion vector obtaining portion configured to obtain one or more motion vectors of the current encoding unit based on the search sub-region;
a residual calculating portion configured to calculate residual information on the current encoding unit according to the motion vectors; and
a bit stream encoding portion configured to encode the residual information on the current encoding unit into a bit stream.

According to a third aspect of the embodiments of this disclosure, there is provided an image decoding method, in which decoding is performed in a pattern matched motion vector derivation manner, the image decoding method including:
determining a search sub-region of a current decoding unit from a plurality of sub-regions of a search region according to one or more motion vectors of one or more decoded units;
obtaining one or more motion vectors of the current decoding unit based on the search sub-region; and
decoding the current decoding unit according to the motion vectors of the current decoding unit and residual information obtained from a bit stream.

According to a fourth aspect of the embodiments of this disclosure, there is provided an image decoding apparatus, performing decoding in a pattern matched motion vector derivation manner, the image decoding apparatus including:
a search sub-region determining portion configured to determine a search sub-region of a current decoding unit from a plurality of sub-regions of a search region according to one or more motion vectors of one or more decoded units;
a motion vector obtaining portion configured to obtain one or more motion vectors of the current decoding unit based on the search sub-region; and
an image decoding portion configured to decode the current decoding unit according to the motion vectors of the current decoding unit and residual information obtained from a bit stream.

According to a fifth aspect of the embodiments of this disclosure, there is provided image processing equipment, including:
an encoder including the image encoding apparatus as described above; and/or
a decoder including the image decoding apparatus as described above.

According to another aspect of the embodiments of this disclosure, there is provided a computer readable program code, which, when executed in an image encoding apparatus or image processing equipment, will cause the image encoding apparatus or the image processing equipment to carry out the image encoding method described above.

According to a further aspect of the embodiments of this disclosure, there is provided a storage medium, including a computer readable program code, which will cause an image encoding apparatus or image processing equipment to carry out the image encoding method described above.

According to yet another aspect of the embodiments of this disclosure, there is provided a computer readable program code, which, when executed in an image decoding apparatus or image processing equipment, will cause the image decoding apparatus or the image processing equipment to carry out the image decoding method described above.

According to a further aspect of the embodiments of this disclosure, there is provided a storage medium, including a computer readable program code, which will cause an image decoding apparatus or image processing equipment to carry out the image decoding method described above.

An advantage of the embodiments of this disclosure exists in that the search region used for obtaining the motion vectors of the current encoding unit is divided into a plurality of sub-regions, the search sub-region of the current encoding unit is determined from a plurality of sub-regions of the search region according to one or more motion vectors of one or more encoded units, and one or more motion vectors of the current encoding unit are obtained based on the search sub-region. Hence, the search region may be reduced, and the number of search points may be lowered, thereby shortening PMMVD encoding/decoding time.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a motion vector in video encoding/decoding;

FIG. 2 is a schematic diagram of acquiring an MV by a decoder in a PMMVD manner;

FIG. 3 is a flowchart of the image encoding method of Embodiment 1 of this disclosure;

FIG. 4 is a schematic diagram of determining a search sub-region of Embodiment 1 of this disclosure;

FIG. 5 is a flowchart of the image decoding method of Embodiment 2 of this disclosure;

FIG. 6 is a schematic diagram of the image encoding apparatus of Embodiment 3 of this disclosure;

FIG. 7 is a schematic diagram of the image decoding apparatus of Embodiment 4 of this disclosure; and

FIG. 8 is a schematic diagram of the encoder/decoder of Embodiment 5 of this disclosure.

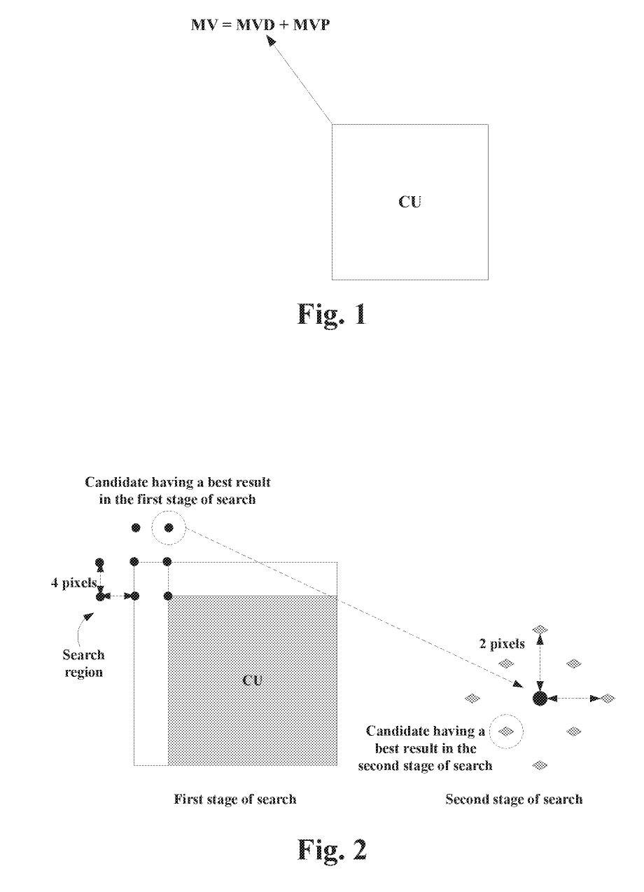

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

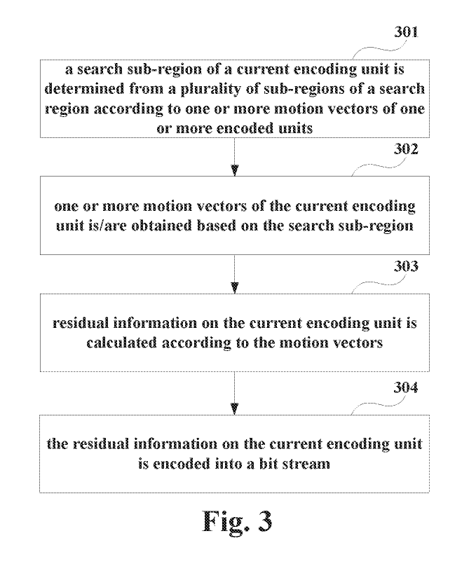

These embodiments of this disclosure provide an image encoding method, in which encoding is performed in a PMMVD manner, which shall be described from an encoder side. FIG. 3 is a flowchart of the image encoding method of the embodiment of this disclosure. As shown in FIG. 3, the image encoding method includes:
301: a search sub-region of a current encoding unit is determined from a plurality of sub-regions of a search region according to one or more motion vectors of one or more encoded units;
302: one or more motion vectors of the current encoding unit is/are obtained based on the search sub-region;
303: residual information on the current encoding unit is calculated according to the motion vectors; and
304: the residual information on the current encoding unit is encoded into a bit stream.

In an embodiment, the search region used for obtaining the motion vectors of the current encoding unit may be predetermined, for example, a search region of PMMVD is still used, and reference may be made to related techniques for particular determination.

In an embodiment, the search region may be divided into a plurality of sub-regions in advance, such as dividing into 2 groups, or 3 groups, etc. However, this disclosure is not limited thereto, and it may also be other numbers. Furthermore, the plurality of sub-regions of the search region may be determined dynamically. For example, after determining that an MV of a left CU corresponds to a certain sub-region, the sub-region may be taken as a first sub-region, and search regions other than the first sub-region may be taken as a second sub-region, etc.

In an embodiment, the search sub-region of the current encoding unit may be determined according to one or more MVs of one or more encoded units. For example, in a case where the MVs of the encoded units correspond to a certain sub-region (such as region 1) of the plurality of sub-regions, the sub-region (such as region 1) is taken as a search sub-region of the current encoding unit.

In an embodiment, the MV of the current CU may be obtained based on the search sub-region. In particular, a two-stage search method may still be employed. For example, a coarse search is performed at an interval of 4 pixels in the first stage, and a search is performed at an interval of 2 pixels in the second stage, and reference may be made to related techniques for particular contents. And furthermore, reference may be made to related techniques for how to calculate the residual information and how to perform the bit stream encoding, which shall not be described herein any further.

Hence, search ranges of the current encoding unit may be reduced according to one or more MVs of one or more encoded units, and the number of search points may be lowered, thereby shortening PMMVD encoding/decoding time.

In an embodiment, the encoded unit may be one or more, such as one or more of a left CU, an upper CU, an upper left CU, and an upper right CU of the current CU; however, this disclosure is not limited thereto. In addition, the encoding unit in this disclosure may be a CU in a general sense, or may be an LCU, or the like. However, this disclosure is not limited thereto, and a size of the encoding unit may be determined according to an actual situation.

How to determine the search sub-regions in this disclosure shall be described below by taking the condition that all the left CU, the upper CU, the upper left CU and the upper right CU are taken into account as an example. However, this disclosure is not limited thereto; for example, only the left CU and the upper CU may be taken into account, or only the left CU may be taken into account, etc.

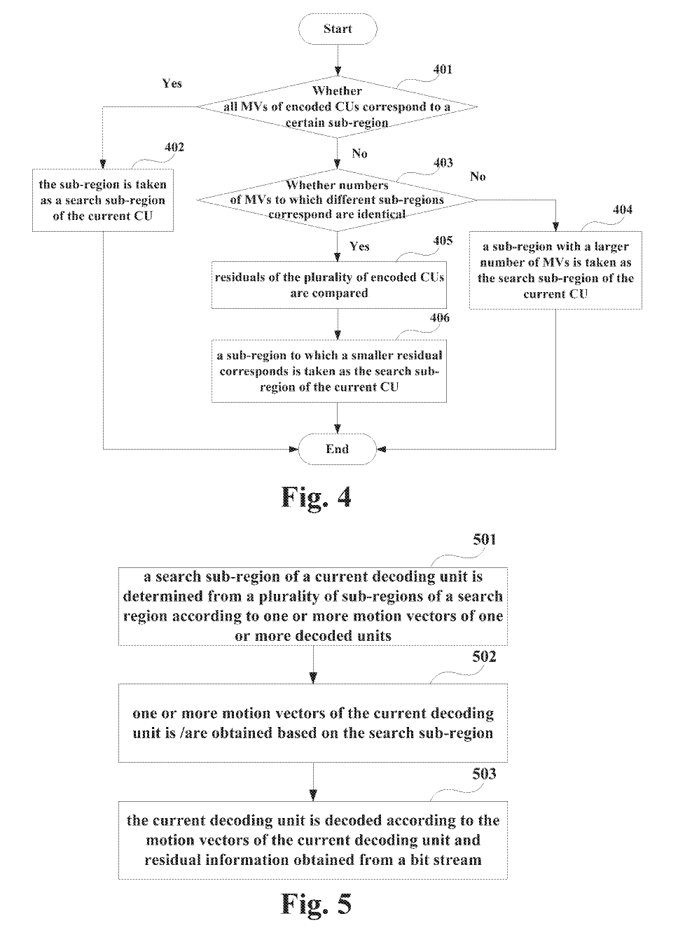

FIG. 4 is a schematic diagram of determining a search sub-region of the embodiment of this disclosure. As shown in FIG. 4, a process of determining the search sub-region may include:
401: it is determined whether all the motion vectors of a plurality of encoded units correspond to a certain sub-region in a plurality of sub-regions, and executing block 402 if yes, otherwise, executing block 403.
402: the sub-region is taken as the search sub-region of the current encoding unit.

For example, if the search region is divided into 2 search sub-regions, and all of an MV of the left CU, an MV of the upper CU, an MV of the upper left CU and an MV of the upper right CU correspond to (or may be referred to as “fall within”) a first sub-region, the first sub-region may be taken as the search sub-region of the current encoding unit.
403: it is determined whether numbers of motion vectors to which different sub-regions respectively correspond are identical, and executing block 404 if no, otherwise, executing block 405.
404: a sub-region with a larger number of motion vectors is taken as the search sub-region of the current encoding unit.

For example, if an MV of the left CU, an MV of the upper CU and an MV of the upper left CU correspond to (or may be referred to as “fall within”) the first sub-region, and an MV of the upper right CU corresponds to a second sub-region, the numbers of the MVs to which the first sub-region and the second sub-region correspond may further be compared; for example, if the number of the MVs to which the first sub-region corresponds in the above example is larger, the first sub-region may be taken as the search sub-region of the current CU.
405: residuals of the plurality of encoded units are compared; and
406: a sub-region to which a smaller residual corresponds is taken as the search sub-region of the current encoding unit.

For example, if an MV of the left CU and an MV of the upper CU correspond to (or may be referred to as “fall within”) the first sub-region, and an MV of the upper left CU and an MV of the upper right CU correspond to the second sub-region, that is, the number of the MVs to which the first sub-region corresponds and the number of the MVs to which the second sub-region corresponds are identical, the residuals of the respective encoded units may further be compared; for example, if the residuals of the left CU and the upper CU are smaller, and the residuals of the upper left CU and the upper right CU are larger, the first sub-region to which the left CU and the upper CU correspond may be taken as the search sub-region of the current CU.

In an embodiment, if the residuals of the encoded CUs are still identical, other rules may further be used to determine the search sub-region of the current CU. For example, in this case, the entire search region is still used to acquire the MV of the current CU, alternatively, either one is randomly selected from the first sub-region and the second sub-region, or the like. For the sake of simplicity, processing when the residuals are still identical is omitted in FIG. 4.

It should be noted that when differences between the residuals are not large, such as being less than a predetermined threshold, it may be deemed that the residuals are identical. Moreover, if sizes of CU blocks are not identical, the residual s need to be further normalized according to the sizes of the CU blocks.

It should be noted that how to determine the search sub-regions is only illustrated above; however, this disclosure is not limited thereto. For example, an order of execution of the blocks or steps may be appropriately adjusted; and furthermore, some other blocks or steps may be added, or some of these blocks or steps may be reduced. And appropriate variants may be made by those skilled in the art according to what is described above, without being limited to the disclosure contained in the above figures.

The blocks or steps or processes related to this disclosure are only described above; however, this disclosure is not limited thereto. The image encoding method may further include other blocks or steps or processes, and reference may be made to the relevant art for particular contents of these blocks or steps or processes.

It can be seen from the above embodiments that the search region used for obtaining the motion vectors of the current encoding unit is divided into a plurality of sub-regions, the search sub-region of the current encoding unit is determined from a plurality of sub-regions of the search region according to one or more motion vectors of one or more encoded units, and one or more motion vectors of the current encoding unit are obtained based on the search sub-region. Hence, the search region may be reduced, and the number of search points may be lowered, thereby shortening PMMVD encoding/decoding time.

### Embodiment 2

These embodiments of this disclosure provide an image decoding method, in which decoding is performed in a PMMVD manner, which shall be described from a decoder side, with contents identical to those in Embodiment 1 being not going to be described herein any further.

FIG. 5 is a flowchart of the image decoding method of the embodiment of this disclosure. As shown in FIG. 5, the image decoding method includes:
501: a search sub-region of a current decoding unit is determined from a plurality of sub-regions of a search region according to one or more motion vectors of one or more decoded units;
502: one or more motion vectors of the current decoding unit is /are obtained based on the search sub-region; and
503: the current decoding unit is decoded according to the motion vectors of the current decoding unit and residual information obtained from a bit stream.

In an embodiment, the search region may be divided into a plurality of sub-regions in advance, such as dividing into 2 groups, or 3 groups, etc. However, this disclosure is not limited thereto, and it may also be other numbers. Furthermore, the plurality of sub-regions of the search region may be determined dynamically.

In an embodiment, the MV of the current CU may be obtained based on the search sub-region. In particular, a two-stage search method may still be employed. For example, a coarse search is performed at an interval of 4 pixels in the first stage, and a search is performed at an interval of 2 pixels in the second stage, and reference may be made to related techniques for particular contents. And furthermore, reference may be made to related techniques for how to obtain the residual information from the bit stream and how to decode the decoding unit, which shall not be described herein any further.

It should be noted that the decoding unit is used in this disclosure with the same size as the encoding unit in Embodiment 1, which are respectively referred to as an encoding unit a decoding unit, for the sake of discrimination. And without causing confusion, a decoding unit in a decoder side may be referred to as a CU or an LCU.

In an embodiment, the decoded units may include one or more of the following: a left decoding unit, an upper decoding unit, an upper left decoding unit, and an upper right decoding unit, of the current decoding unit; however, this disclosure is not limited thereto.

In an embodiment, the determining a search sub-region of a current decoding unit from a plurality of sub-regions of a search region according to one or more motion vectors of one or more decoded units may include: taking a certain sub-region as the search sub-region of the current decoding unit when one or more motion vectors of a decoded unit correspond to the sub-region in the plurality of sub-regions.

In an embodiment, the determining a search sub-region of a current decoding unit from a plurality of sub-regions of a search region according to one or more motion vectors of one or more decoded units may further include: determining whether all the motion vectors of the plurality of decoded units correspond to a certain sub-region in the plurality of sub-regions; and taking the sub-region as the search sub-region of the current decoding unit when all the motion vectors of the plurality of decoded units correspond to the sub-region in the plurality of sub-regions.

The image decoding may further include: comparing numbers of motion vectors to which different sub-regions correspond when the motion vectors of the plurality of decoded units correspond to the different sub-regions in the plurality of sub-regions; and taking a sub-region to which a larger number of motion vectors corresponds as the search sub-region of the current decoding unit.

The image decoding may further include: comparing residuals of the plurality of decoded units when the numbers of the motion vectors to which the different sub-regions respectively correspond are identical; and taking a sub-region to which a smaller residual corresponds as the search sub-region of the current decoding unit.

The blocks or steps or processes related to this disclosure are only described above; however, this disclosure is not limited thereto. The image decoding method may further include other blocks or steps or processes, and reference may be made to the prior art for particular contents of these blocks or steps or processes.

It can be seen from the above embodiments that the search region used for obtaining the motion vectors of the current decoding unit is divided into a plurality of sub-regions, the search sub-region of the current decoding unit is determined from a plurality of sub-regions of the search region according to one or more motion vectors of one or more decoded units, and one or more motion vectors of the current decoding unit are obtained based on the search sub-region. Hence, the search region may be reduced, and the number of search points may be lowered, thereby shortening PMMVD encoding/decoding time.

### Embodiment 3

These embodiments of this disclosure provide an image encoding apparatus, performing encoding in a PMMVD manner, which corresponds to the image encoding method of Embodiment 1, with identical contents being not going to be described herein any further.

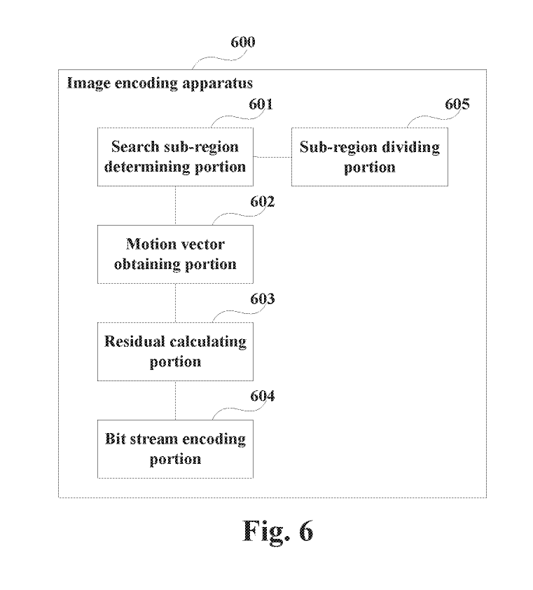

FIG. 6 is a schematic diagram of the image encoding apparatus of the embodiment of this disclosure. As shown in FIG. 6, the image encoding apparatus 600 includes:
a search sub-region determining portion 601 configured to determine a search sub-region of a current encoding unit from a plurality of sub-regions of a search region according to one or more motion vectors of one or more encoded units;
a motion vector obtaining portion 602 configured to obtain one or more motion vectors of the current encoding unit based on the search sub-region;
a residual calculating portion 603 configured to calculate residual information on the current encoding unit according to the motion vectors; and
a bit stream encoding portion 604 configured to encode the residual information on the current encoding unit into a bit stream.

As shown in FIG. 6, the image encoding apparatus 600 may further include:
a sub-region dividing portion 605 configured to divide the search region used for obtaining the motion vectors of the current encoding unit into a plurality of sub-regions.

In an embodiment, the encoded units may include one or more of the following: a left encoding unit, an upper encoding unit, an upper left encoding unit, and an upper right encoding unit, of the current encoding unit; however, this embodiment is not limited thereto.

In an embodiment, the search sub-region determining portion 601 may be configured to: take a certain sub-region as the search sub-region of the current encoding unit when one or more motion vectors of an encoded unit correspond to the sub-region in the plurality of sub-regions.

The search sub-region determining portion 601 may further be configured to: determine whether all the motion vectors of the plurality of encoded units correspond to a certain sub-region in the plurality of sub-regions; and take the sub-region as the search sub-region of the current encoding unit when all the motion vectors of the plurality of encoded units correspond to the sub-region in the plurality of sub-regions.

The search sub-region determining portion 601 may further be configured to: compare numbers of motion vectors to which different sub-regions correspond when the motion vectors of the plurality of encoded units correspond to the different sub-regions in the plurality of sub-regions; and take a certain sub-region to which a larger number of motion vectors corresponds as the search sub-region of the current encoding unit.

The search sub-region determining portion 601 may further be configured to: compare residuals of the plurality of encoded units when the numbers of the motion vectors to which the different sub-regions respectively correspond are identical; and take a certain sub-region to which a smaller residual corresponds as the search sub-region of the current encoding unit.

It should be noted that the components related to this disclosure are only described above; however, this disclosure is not limited thereto. The image encoding apparatus may further include other components or modules, and reference may be made to the prior art for particular contents of these components or modules.

It can be seen from the above embodiments that the search region used for obtaining the motion vectors of the current encoding unit is divided into a plurality of sub-regions, the search sub-region of the current encoding unit is determined from a plurality of sub-regions of the search region according to one or more motion vectors of one or more encoded units, and one or more motion vectors of the current encoding unit are obtained based on the search sub-region. Hence, the search region may be reduced, and the number of search points may be lowered, thereby shortening PMMVD encoding/decoding time.

### Embodiment 4

These embodiments of this disclosure provide an image decoding apparatus, performing decoding in a PMMVD manner, which corresponds to the image decoding method of Embodiment 2, with identical contents being not going to be described herein any further.

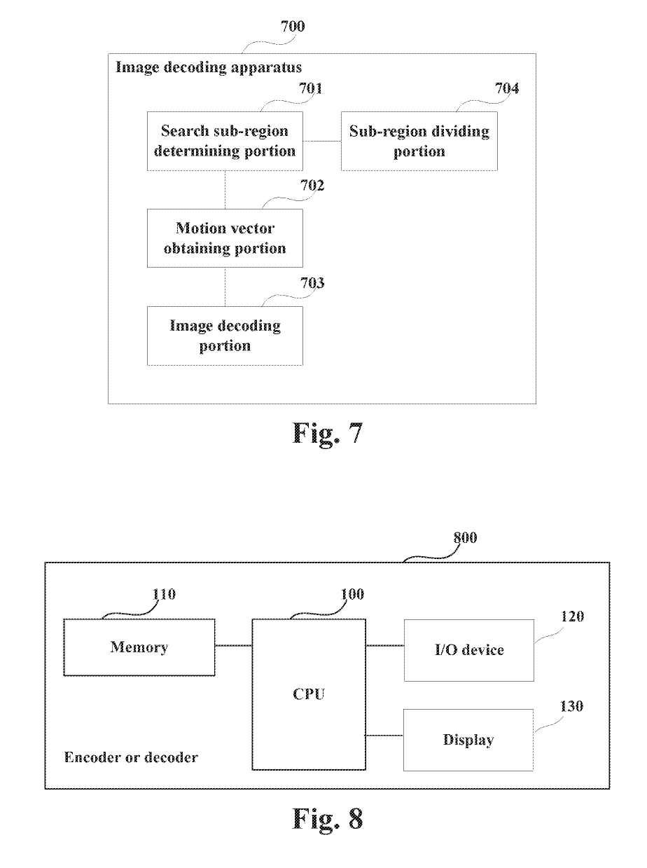

FIG. 7 is a schematic diagram of the image decoding apparatus of the embodiment of this disclosure. As shown in FIG. 7, the image decoding apparatus 700 includes:
a search sub-region determining portion 701 configured to determine a search sub-region of a current decoding unit from a plurality of sub-regions of a search region according to one or more motion vectors of one or more decoded units;
a motion vector obtaining portion 702 configured to obtain one or more motion vectors of the current decoding unit based on the search sub-region; and
an image decoding portion 703 configured to decode the current decoding unit according to the motion vectors of the current decoding unit and residual information obtained from a bit stream.

As shown in FIG. 7, the image decoding apparatus 700 may further include:
a sub-region dividing portion 704 configured to divide the search region used for obtaining the motion vectors of the current decoding unit into a plurality of sub-regions.

In an embodiment, the decoded units may include one or more of the following: a left decoding unit, an upper decoding unit, an upper left decoding unit, and an upper right decoding unit, of the current decoding unit; however, this disclosure is not limited thereto.

In this embodiment, the search sub-region determining portion 701 may be configured to: take a sub-region as the search sub-region of the current decoding unit when one or more motion vectors of a decoded unit correspond to the sub-region in the plurality of sub-regions.

The search sub-region determining portion 701 may further be configured to: determine whether all the motion vectors of the plurality of decoded units correspond to a certain sub-region in the plurality of sub-regions; and take the sub-region as the search sub-region of the current decoding unit when all the motion vectors of the plurality of decoded units correspond to the sub-region in the plurality of sub-regions.

The search sub-region determining portion 701 may further be configured to: compare numbers of motion vectors to which different sub-regions correspond when the motion vectors of the plurality of decoded units correspond to the different sub-regions in the plurality of sub-regions; and take a sub-region to which a larger number of motion vectors corresponds as the search sub-region of the current decoding unit.

The search sub-region determining portion 701 may further be configured to: compare residuals of the plurality of decoded units when the numbers of the motion vectors to which the different sub-regions respectively correspond are identical; and take a sub-region to which a smaller residual corresponds as the search sub-region of the current decoding unit.

It should be noted that the components related to this disclosure are only described above; however, this disclosure is not limited thereto. The image encoding apparatus may further include other components or modules, and reference may be made to the prior art for particular contents of these components or modules.

It can be seen from the above embodiments that the search region used for obtaining the motion vectors of the current decoding unit is divided into a plurality of sub-regions, the search sub-region of the current decoding unit is determined from a plurality of sub-regions of the search region according to one or more motion vectors of one or more decoded units, and one or more motion vectors of the current decoding unit are obtained based on the search sub-region. Hence, the search region may be reduced, and the number of search points may be lowered, thereby shortening PMMVD encoding/decoding time.

### Embodiment 5

These embodiments of this disclosure provide image processing equipment, including an encoder and/or a decoder; the encoder includes the image encoding apparatus as described in Embodiment 3, and the decoder includes the image decoding apparatus as described in Embodiment 4.

FIG. 8 is a schematic diagram of the encoder of the embodiment of this disclosure. As shown in FIG. 8, an encoder 800 may include a central processing unit (CPU) 100 and a memory 110, the memory 110 being coupled to the central processing unit 100. The memory 110 may store various data, and furthermore, it may store a program for information processing, and execute the program under control of the central processing unit 100.

In one embodiment, the functions of the image encoding apparatus 600 may be integrated into the central processing unit 100. The central processing unit 100 may be configured to carry out the image encoding method described in Embodiment 1.

In another embodiment, the image encoding apparatus 600 and the central processing unit 100 may be configured separately. For example, the image encoding apparatus 600 may be configured as a chip connected to the central processing unit 100, with its functions being carried out under control of the central processing unit 100.

For example, the central processing unit 100 may be configured to perform following control: determining a search sub-region of a current coding unit from a plurality of sub-regions of a search region according to one or more motion vectors of one or more encoded units; obtaining one or more motion vectors of the current encoding unit based on the search sub-region; calculating residual information on the current encoding unit according to the motion vectors; and encoding the residual information on the current encoding unit into a bit stream.

Furthermore, as shown in FIG. 8, the encoder 800 may include an input/output (I/O) device 120, and a display 130, etc. Functions of the above components are similar to those in the relevant art, and shall not be described herein any further. It should be noted that the encoder 800 does not necessarily include all the parts shown in FIG. 8, and furthermore, the encoder 800 may include parts not shown in FIG. 8, and the relevant art may be referred to.

The embodiment of this disclosure further provides a decoder, reference being able to be made to FIG. 8 for a structure of the decoder.

For example, the central processing unit 100 may be configured to perform following control: determining a search sub-region of a current decoding unit from a plurality of sub-regions of a search region according to one or more motion vectors of one or more decoded units; obtaining one or more motion vectors of the current decoding unit based on the search sub-region; and decoding the current decoding unit according to the motion vectors of the current decoding unit and residual information obtained from a bit stream.

An embodiment of the present disclosure provides a computer readable program code, which, when executed in an image encoding apparatus or image processing equipment, will cause the image encoding apparatus or the image processing equipment to carry out the image encoding method described in Embodiment 1.

An embodiment of the present disclosure provides a storage medium, including a computer readable program code, which will cause an image encoding apparatus or image processing equipment to carry out the image encoding method described in Embodiment 1.

An embodiment of the present disclosure provides a computer readable program code, which, when executed in an image decoding apparatus or image processing equipment, will cause the image decoding apparatus or the image processing equipment to carry out the image decoding method described in Embodiment 2.

An embodiment of the present disclosure provides a storage medium, including a computer readable program code, which will cause an image decoding apparatus or image processing equipment to carry out the image decoding method described in Embodiment 2.

The above apparatuses and method of this disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 6 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the figures may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the figures may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. An image encoding method, in which encoding is performed in a pattern matched motion vector derivation manner, the image encoding method including:
determining a search sub-region of a current coding unit from a plurality of sub-regions of a search region according to one or more motion vectors of one or more encoded units;
obtaining one or more motion vectors of the current encoding unit based on the search sub-region;
calculating residual information on the current encoding unit according to the motion vectors; and
encoding the residual information on the current encoding unit into a bit stream.

Supplement 2. The image encoding method according to supplement 1, wherein the image encoding method further includes:
dividing the search region used for obtaining the motion vectors of the current encoding unit into a plurality of sub-regions.

Supplement 3. The image encoding method according to supplement 1, wherein the encoded units include one or more of the following: a left encoding unit, an upper encoding unit, an upper left encoding unit, and an upper right encoding unit, of the current encoding unit.

Supplement 4. The image encoding method according to supplement 1, wherein the determining a search sub-region of a current coding unit from a plurality of sub-regions of a search region according to one or more motion vectors of one or more encoded units includes:
taking a certain sub-region as the search sub-region of the current encoding unit when one or more motion vectors of an encoded unit correspond to the sub-region in the a plurality of sub-regions.

Supplement 5. The image encoding method according to supplement 1, wherein the determining a search sub-region of a current coding unit from a plurality of sub-regions of a search region according to one or more motion vectors of one or more encoded units includes:
determining whether all the motion vectors of the plurality of encoded units correspond to a certain sub-region in the plurality of sub-regions; and
taking the sub-region as the search sub-region of the current encoding unit when all the motion vectors of the plurality of encoded units correspond to the sub-region in the plurality of sub-regions.

Supplement 6. The image encoding method according to supplement 1, wherein the image encoding method further includes:
comparing numbers of motion vectors to which different sub-regions correspond when the motion vectors of the plurality of encoded units correspond to the different sub-regions in the plurality of sub-regions; and
taking a sub-region to which a larger number of motion vectors corresponds as the search sub-region of the current encoding unit.

Supplement 7. The image encoding method according to supplement 1, wherein the image encoding method further includes:
comparing residuals of the plurality of encoded units when the numbers of the motion vectors to which the different sub-regions respectively correspond are identical; and
taking a sub-region to which a smaller residual corresponds as the search sub-region of the current encoding unit.

Supplement 8. An image decoding method, in which decoding is performed in a PMMVD manner, the image decoding method includes:
determining a search sub-region of a current decoding unit from a plurality of sub-regions of a search region according to one or more motion vectors of one or more decoded units;
obtaining one or more motion vectors of the current decoding unit based on the search sub-region; and
decoding the current decoding unit according to the motion vectors of the current decoding unit and residual information obtained from a bit stream.

Supplement 9. The image decoding method according to supplement 8, wherein the image decoding method further includes:
dividing the search region used for obtaining the motion vectors of the current decoding unit into a plurality of sub-regions.

Supplement 10. The image decoding method according to supplement 8, wherein the decoded units include one or more of the following: a left decoding unit, an upper decoding unit, an upper left decoding unit, and an upper right decoding unit, of the current decoding unit.

Supplement 11. The image decoding method according to supplement 8, wherein the determining a search sub-region of a current decoding unit from a plurality of sub-regions of a search region according to one or more motion vectors of one or more decoded units includes:
taking a sub-region as the search sub-region of the current decoding unit when one or more motion vectors of a decoded unit correspond to the sub-region in the plurality of sub-regions.

Supplement 12. The image decoding method according to supplement 8, wherein the determining a search sub-region of a current decoding unit from a plurality of sub-regions of a search region according to one or more motion vectors of one or more decoded units includes:
determining whether all the motion vectors of the plurality of decoded units correspond to a certain sub-region in the plurality of sub-regions; and
taking the sub-region as the search sub-region of the current decoding unit when all the motion vectors of the plurality of decoded units correspond to the sub-region in the plurality of sub-regions.

Supplement 13. The image decoding method according to supplement 12, wherein the image decoding method further includes:
comparing numbers of motion vectors to which different sub-regions correspond when the motion vectors of the plurality of decoded units correspond to the different sub-regions in the plurality of sub-regions; and
taking a sub-region to which a larger number of motion vectors corresponds as the search sub-region of the current decoding unit.

Supplement 14. The image decoding method according to supplement 13, wherein the image decoding method further includes:
comparing residuals of the plurality of decoded units when the numbers of the motion vectors to which the different sub-regions respectively correspond are identical; and
taking a sub-region to which a smaller residual corresponds as the search sub-region of the current decoding unit.

1. An image encoding apparatus to perform encoding in a pattern matched motion vector derivation manner, the image encoding apparatus comprising:
a memory; and
a processor coupled to the memory and to,
determine a search sub-region of a current encoding unit, from a plurality of sub-regions of a search region according to a motion vector of an encoded unit;
obtain a motion vector of the current encoding unit based on the search sub-region;
calculate residual information on the current encoding unit according to the motion vector; and
encode the residual information on the current encoding unit into a bit stream.

2. The image encoding apparatus according to claim 1, wherein the processor is to:
divide the search region used for obtaining the motion vector of the current encoding unit into the plurality of sub-regions.

3. The image encoding apparatus according to claim 1, wherein the encoded unit is among a plurality of encoded units comprising one or more of the following: a left encoded unit, an upper encoded unit, an upper left encoded unit, and an upper right encoded unit, corresponding to the current encoding unit.

4. The image encoding apparatus according to claim 1, wherein the processor is to take a sub-region, among the sub-regions, as the search sub-region of the current encoding unit when the motion vector of the encoded unit corresponds to the sub-region in the plurality of sub-regions.

5. The image encoding apparatus according to claim 1, wherein the motion vector is a plurality of motion vectors from among a plurality of encoded units, and the processor is to:
determine whether plural motion vectors among the plurality of motion vectors from among the plurality of encoded units correspond to a certain sub-region in the plurality of sub-regions; and
take the sub-region as the search sub-region of the current encoding unit when the plural motion vectors of the plurality of encoded units correspond to the sub-region in the plurality of sub-regions.

6. The image encoding apparatus according to claim 5, wherein the processor is to:
perform a comparison of number of motion vectors among the plural motion vectors to which different sub-regions respectively correspond, when the plural motion vectors of the encoded units correspond to the different sub-regions in the plurality of sub-regions; and
take a sub-region to which a larger number of motion vectors corresponds according to the comparison, as the search sub-region of the current encoding unit.

7. The image encoding apparatus according to claim 6, wherein the processor is to:
perform a comparison of residuals of the plurality of encoded units when the number of the motion vectors to which the different sub-regions respectively correspond are identical; and
take a sub-region to which a smaller residual corresponds according to the comparison as the search sub-region of the current encoding unit.

8. An image decoding apparatus to perform decoding in a pattern matched motion vector derivation manner, the image decoding apparatus comprising:
a memory; and
a processor coupled to the memory and to,
determine a search sub-region of a current decoding unit, from a plurality of sub-regions of a search region according to a more motion vector of a plurality of decoded units;
obtain a motion vector of the current decoding unit based on the search sub-region; and
decode the current decoding unit according to the motion vector of the current decoding unit and residual information obtained from a bit stream.

9. The image decoding apparatus according to claim 8, wherein the processor is to divide the search region used for obtaining the motion vector of the current decoding unit into a plurality of sub-regions.

10. The image decoding apparatus according to claim 8, wherein the decoded unit is among a plurality of decoded units comprising one or more of the following: a left decoded unit, an upper decoded unit, an upper left decoded unit, and an upper right decoded unit, corresponding to the current decoding unit.

11. The image decoding apparatus according to claim 8, wherein the processor is to: take a sub-region, among the sub-regions, as the search sub-region of the current decoding unit when the motion vector of the decoded unit corresponds to the sub-region in the plurality of sub-regions.

12. The image decoding apparatus according to claim 8, wherein the motion vector is a plurality of motion vectors from among a plurality of encoded units, and the processor is to:
determine whether plural motion vectors among the plurality of motion vectors from among the plurality of decoded units correspond to a certain sub-region in the plurality of sub-regions; and
take the sub-region as the search sub-region of the current decoding unit when the plural motion vectors of the plurality of decoded units correspond to the sub-region in the plurality of sub-regions.

13. The image decoding apparatus according to claim 12, wherein the processor is to:
perform a comparison of number of motion vectors among the plural motion vectors to which different sub-regions respectively correspond, when the plural motion vectors of the decoded units correspond to the different sub-regions in the plurality of sub-regions; and
take a sub-region to which a larger number of motion vectors corresponds according to the comparison as the search sub-region of the current decoding unit.

14. The image decoding apparatus according to claim 13, wherein the processor is to:
perform a comparison of residuals of the plurality of decoded units when the number of the motion vectors to which the different sub-regions respectively correspond are identical; and
take a sub-region to which a smaller residual corresponds according to the comparison as the search sub-region of the current decoding unit.

15. An image processing equipment, comprising:
an encoder comprising the image encoding apparatus as claimed in claim 1; and/or
a decoder comprising the image decoding apparatus as claimed in claim 8.
